(19) United States
(12) Patent Application Publication
(10) Pub. No.: US 2025/0269461 A1
(43) Pub. Date: Aug. 28, 2025

(54) LASER ALIGNMENT IN 3D PRINTING SYSTEM

(71) Applicant: Freeform Future Corp., Hawthorne, CA (US)

(72) Inventors: Tasso Lappas, Pasadena, CA (US); Rueben Mendelsberg, Aurora, CO (US)

(21) Appl. No.: 19/062,785

(22) Filed: Feb. 25, 2025

Related U.S. Application Data
(60) Provisional application No. 63/558,251, filed on Feb. 27, 2024.

(51) Int. Cl. B23K 26/042; B23K 26/06; B23K 26/067; B23K 26/342; B33Y 30/00; B33Y 50/02

(52) U.S. Cl. CPC B23K 26/042; B23K 26/0643; B23K 26/067; B23K 26/342; B33Y 30/00; B33Y 50/02

(57) ABSTRACT

A method includes generating, for a first beamlet of a lasing module, first calibration data that represents a first position of first mirrors for directing a first laser beam of the first beamlet to a location within a build area, generating, for a second beamlet of the lasing module, second calibration data that represents a second position of second mirrors for directing a second laser beam of the second beamlet to the location, causing a third beamlet to output a third laser beam at the location, receiving, via a first imaging sensor of the first beamlet, first image data representing the third laser beam, receiving, via a second imaging sensor of the second beamlet, second image data representing the third laser beam, generating a first alignment correction table for directing the first laser beam, and generating a second alignment correction table for directing the first laser beam.

### CROSS-REFERENCE TO RELATED APPLICATIONS

This application claims priority to U.S. Provisional Patent Application No. 63/558,251, filed Feb. 27, 2024, entitled “Laser Aligning in 3D Printing Systems,” the entirety of which is herein incorporated by reference.

### BACKGROUND

Additive manufacturing or 3D printing offers multiple benefits over traditional manufacturing processes. For example, additive manufacturing allows for more complex parts to be manufactured, eliminating many design constraints of previous manufacturing processes. Additionally, additive manufacturing reduces material costs and waste. However, thus far, print times are relatively long and throughput for existing additive manufacturing systems are low compared to conventional manufacturing processes. Also, additive manufacturing techniques have not been as robust, stable, and/or repeatable as traditional manufacturing processes. Accordingly, there is a need for improvements to additive manufacturing processes and techniques.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features. The systems depicted in the accompanying figures are not to scale and components within the figures may be depicted not to scale with each other.

FIG. 1 illustrates an example 3D printing system, including a lasing module having optical assemblies with beamlet(s), according to an example of the present disclosure.

FIGS. 2A and 2B illustrate examples of components of the optical assemblies of FIG. 1, according to an example of the present disclosure.

FIG. 3 illustrates an example scenario for generating calibration data for the beamlet(s) of the optical assemblies of FIG. 1, according to an example of the present disclosure.

FIG. 4 illustrates an example scenario for generating an alignment correction table for the beamlet(s) of the optical assemblies of FIG. 1, according to an example of the present disclosure.

FIG. 5 illustrates an example scenario for aligning the beamlet(s) of the optical assemblies of FIG. 1, according to an example of the present disclosure.

FIG. 6 illustrates example points on a build area of a build module of the 3D printing system of FIG. 1 for aligning the beamlet(s) of the optical assemblies, according to an example of the present disclosure.

FIGS. 7-10 illustrate various processes associated with aligning the beamlet(s) of the optical assemblies of FIG. 1, according to an example of the present disclosure.

### DETAILED DESCRIPTION

This application is directed, at least in part, to systems and methods that align laser beams used in additive manufacturing, such as powder-bed fusion. In powder-bed fusion, powdered metal is selectively melted using lasers (e.g., laser beam, electron beam, thermal print head, etc.). The lasers may be a component of a lasing module of a 3D printing system, where the laser beams melt powdered metal disposed in a build module of the 3D printing system. In some instances, the build module may include a container in which the powdered metal is disposed and within or on which the parts are manufactured. As explained herein, the laser beams may be steered toward respective positions on build area(s) disposed across one or more build modules for melting the powdered metal. In doing so, the laser beam(s) create melt pools of powdered metal, and as the melt pools solidify, structures of the part are formed. The lasing module may include any number of laser(s), and the laser(s) may be aligned with one another such that the laser(s) are individually and/or collectively steerable to specific locations on the build area(s). In doing so, parts may be manufactured with increased precision and accuracy and/or with fewer defects.

The lasing module may include a plurality of optical assemblies with the laser(s). In some instances, the lasing module may include any number of the optical assemblies (e.g., one, two, three, . . . N, where N is an integer), and the optical assemblies may include any number of the lasers (e.g., one, two, three, . . . M, where M is an integer). The optical assemblies may also include mirrors (e.g., galvo mirrors) that allow the laser beam(s) to be selectively, individually, and/or collectively steered towards particular locations on the build area. In some instances, the laser beam(s) may be steered to all locations on the build area, or a particular region, segment, etc., of the build area. The optical assemblies may also include lens(es) that adjusts a spot size or focal length of the laser beam(s). Collectively, the mirrors and the lens(es) may help to steer the laser beams. Further, imaging sensor(s) (e.g., high-speed cameras) of the optical assemblies may monitor the build area, such as a melt pool of the powdered metal, during operation to provide feedback for use in driving and steering the laser beam(s).

In some instances, the optical assemblies may include individual lasers and respective mirror(s), lens(es), and imaging sensor(s) for steering laser beams generated by the individual lasers. In some instances, the optical assemblies may include one or more beamlets, where individual beamlets include a laser, mirror(s) for steering the laser beam of the laser, lens(es) for adjusting the spot size of the laser beam, an imaging sensor for imaging the laser beam (or more generally, the build area(s)), and so forth.

One or more controllers may control the various lens(es), mirror(s), laser(s), imaging sensor(s), and/or other components of the individual beamlets. For example, each of the beamlets may include a respective controller for controlling components thereof. The controller may cause the mirror(s) to steer the laser beam toward particular locations on the build area, may cause the lens(es) to adjust for altering the focal length of the laser beam (e.g., based on the imaging beam(s)), and/or may control an intensity (e.g., power, energy, etc.) of the laser beams, and so forth. As such, the individual beamlets of the optical assemblies may be individually controlled. In some instances, a central controller or other computing device of the 3D printing system may control the plurality of controllers disposed across the optical assemblies.

The mirror(s) and/or lens(es) serve to direct or “steer” the laser beams generated by the lasers towards the build area as well as alter characteristic(s) of the laser beam (e.g., spot size, focal length, etc.). For example, each laser may produce a laser beam oriented towards the build area using a combination of lens(es) and mirror(s). The mirror(s) and/or lens(es) provide respective paths for the laser beams, from the lasers to the powdered metal. The mirror(s) and/or lens(es) may steer or otherwise direct the laser beams towards locations within the build area. In some instances, individual beamlets may include a first galvo mirror and a second galvo mirror with single-axis steering, which may be used to collectively steer the laser beams throughout locations in the build area. In other examples, one or more galvo mirrors with multi-axis steering may be used to steer the laser beams throughout the build area. Moreover, respective lens(es) in the respective beam paths may be adjusted along the beam path (e.g., using a voice-coil, geared, or belt-driven linear actuator) or have their shape adjusted to change the focus (e.g., using piezo-driven deformable mirrors/lenses, deformable refractive surfaces, or other focusing elements) of the laser beams.

The imaging sensor(s) (e.g., a complementary metal oxide semiconductor (CMOS) camera, a high-speed camera, digital camera, etc.) detects a location of a melt pool associated with the laser beam(s). For example, the imaging sensor(s) may receive imaging beam(s) corresponding to a location of the melt pool within the build area. Such information may be used to determine characteristic(s) of the melt pool, such as the location of the melt pool, the size of the melt pool, and/or current condition (e.g., temperature, strain, stress, etc.) of the melt pool. In some instances, the imaging sensor(s) may be able to detect the location of the melt pool to within ten microns. The detected location, size, and/or condition may be used to improve the accuracy or precision with which the laser beam(s) are steered. For example, based on imaging of the melt pool, the lens(es) and/or mirror(s) may be adjusted to adjust a focal length individual laser beams and/or steer the laser beams to different locations within the build area. This permits the lasers to be accurately and precisely steered to specific locations within the build area to ensure that parts are adequately manufactured.

For ease of reference, light reflected from the melt pool that travels from the melt pool to the imaging sensors of the beamlets may be referred to herein as an “imaging beam” or “imaging beams.” In some instances, the imaging beam(s) may substantially parallel or overlap with at least a portion of the path of the laser beam. For example, to reach the imaging sensors, the imaging beams may traverse a path substantially parallel to the path of a respective laser beam through at least a portion of the optical assembly. In some instances, as used herein, the laser beam may be considered a “forward path” of the beamlet. The imaging beam may be considered an “inverse path” or “reflected path” of the beamlet.

Given that the lasing module may include a plurality of optical assemblies and/or that the optical assemblies may include one or more beamlets, the beamlets may be aligned to ensure that parts are accurately manufactured. In some instances, aligning the beamlets may ensure that the laser beams across the optical assemblies are steerable to the same point or location on the build area. In some instances, the alignment techniques may include steering a specified group (e.g., a subset or all) of the lasers in concert and confirming that the specified group of the lasers are concurrently steered to the same point or location on the build area. This ensures that when the laser(s) are instructed to perform specific tasks and melt powdered metal at a specific location on the build area, the lasers can generate laser beams that are steered to the specific location within and within a specified operational tolerance (e.g., +/−10 microns). This also ensures that the beamlets agree on where points are across the build area. Stated alternatively, if the lasers are not aligned with one another within the specified operational tolerance and do not have the same point of reference on the build area, the lasers may be directed to different points on the build area. This may result in poor control of the melt pool, slower processing, and inconsistent part quality (e.g., deformation, seams, or other defects in the part being manufactured), just to name a few challenges.

In some instances, aligning the lasers may include different stages. At a first stage, components of the individual beamlets may be aligned. For example, as noted above, individual beamlets include a laser and an imaging sensor, and the first stage may involve testing, validating, and qualifying that the lens(es) can focus the laser beam to different spot sizes. Throughout their range of spot sizes, the imaging sensor may be tuned to image the laser beams. At the first stage, the laser beam and the imaging beam may be aligned (e.g., the forward path and inverse path), meaning that the imaging sensor is aligned to image the laser beam generated by the laser. The alignment at the first stage permits the imaging sensor to understand and know where the laser beam is located as the controller focuses the laser beam. In other words, the imaging sensor can accurately and precisely image the laser beam. Lens(es), mirror(s), etc., may be controlled to align the imaging beam and the laser beam.

At a second stage, the beamlets may be calibrated with the galvo mirror(s). For example, the galvo mirror(s) may be moveable over a range of positions, and different combinations of steering the galvo mirror(s) may be achieved to direct the laser beam to particular points within the build area. In some instances, a grid, coordinate system, or other set of fiducials on a calibration map may be used to calibrate the galvo mirror(s). For example, the galvo mirror(s) may be actuated over a range of positions to understand the position of each galvo mirror that is needed to steer the lasers and image the locations on the calibration map. As the galvo mirror(s) are actuated, the imaging sensor may image the points on the grid to understand how the galvo mirror(s) are actuated to image a particular point on the calibration map. Since the imaging sensor has been previously aligned with the laser, in some examples, the laser beam may not need to be actuated to understand where the laser beam will be directed at particular positions of the galvo mirror(s). That is, by aligning the imaging beam and the laser beam at the first stage, the second stage may not require the laser beam to be actuated.

In some instances, the calibration map may represent an X-Y coordinate system, and the galvo mirror(s) may be actuated to various positions for the imaging sensor to image the locations on the X-Y coordinate system. As an example, to direct the laser beam to X1, Y1 on the coordinate map, the positions of the galvo mirror(s) may be recorded, to direct the laser beam to X2, Y2 on the coordinate map, the positions of the galvo mirror(s) may be recorded, and so forth. As the galvo mirror(s) are steered, the positions of the galvo mirror(s) are recorded, and calibration data (e.g., a calibration table) is generated. Each of the beamlets of the optical assemblies may include an associated calibration table, where the calibration table represents a position of each of the galvo mirror(s) (e.g., rotation, degree, orientation, etc.) to direct a laser beam to a particular point in coordinate space (e.g., X-Y coordinate position). The same is true for the position or settings of the lens(es) to steer the laser beams to particular points on the calibration map.

In some instances, the first stage and/or the second stage may be performed offline, that is, prior to installation or commissioning of the optical assemblies on the lasing module. Performing the first stage and/or the second stage offline may reduce the time to align the optical assemblies when installed (or commissioned) on the lasing module. In some instances, after installation of the beamlets on the lasing module, a third stage may be performed to align the individual beamlets with one another or to align the beamlets across the optical assemblies. As introduced above, aligning the individual beamlets ensures that the beamlets are each oriented within the same coordinate space on the build area. For example, to manufacture a part, laser(s) from multiple optical assemblies at different locations on the lasing module may be instructed to steer their laser beams to particular points on the build area. If the beamlets are not aligned, the beamlets may not be “looking” at the same point on the build area and parts may be incorrectly manufactured. This may mean that the beamlets are not looking at the same point, or have different interpretations of where the point is on the build area. As such, each beamlet may need to be aligned within a certain accuracy (operational tolerance) to ensure that the beamlets reference the same points on the build area.

In some instances, after installing the optical modules, but before manufacturing of a part, the beamlets may image a grid, coordinate system, or other set of fiducials on the lasing module, the build module, etc., or other structure. Here, the imaging beams may image the fiducials to determine a height of the build module (or a distance to the build module). The calibration table may be updated during this process and the lasers may not output laser beams. Next, to align the beamlets, a certain laser (e.g., master laser) may be designated and the laser may generate a laser beam on the build area. The other beamlets may go and “find” the laser beam generated by the master laser. As the other beamlets locate the laser beam, imaging beams of a master laser beam are received by the imaging sensors of the beamlets that are not outputting laser beams. By imaging the master laser beam, the location of the master laser beam on the build area is determined. This location may be used to recalibrate the calibration data. For example, locations, orientations, etc., of the mirror(s) and/or the lens(es) may be recorded to recalibrate the beamlets. As each beamlet may have its own calibration data, as generated from the first stage and/or the second stage, the third stage may align all of the beamlets with one another, ensuring that the laser beams across the optical assemblies are capable of being steered to the same point on the build area and that the beamlets agree on where the same point is on the build area. This may involve an update to the calibration data, or the generation of an alignment correction table (or more generally, alignment correction data). In some instances, the calibration data may be organized within a calibration table, where the calibration table indicates the steering, or position, of the mirror(s) and/or the lens(es) to direct a laser beam to a location on a build area and/or to image the location on the build area.

As each beamlet has its own imaging sensor, the imaging sensors across the beamlets that image the master laser beam may eliminate error within the 3D printing system. For example, the imaging sensors may compute redundant information, with the multiple imaging sensors(s) “looking” at the same location. As such, using multiple imaging sensors enables the beamlets to “agree” where the points are on the build module. This helps to ensure that across the beamlets, the beamlets agree on the location on the build module (i.e., what the beamlets are looking at).

As an illustration, envision that for a first beamlet of a first optical assembly, calibration data of the first beamlet may indicate that a first position of a first galvo mirror and a second position of a second galvo mirror direct the first laser beam to a particular point (e.g., 0,0 in coordinate space). This first position and second position may be obtained at the second stage. The calibration data may also indicate positions or settings of the lens(es). Upon installation, at the third stage, the beamlet may be calibrated to/on the build module or the lasing module (e.g., via a grid-based system), to determine a distance to the build module and/or its position on the lasing module (e.g., by imaging fiducials on the build module or other structure). Therein, the calibration data may be updated. Next, while the beamlet has its own calibration data, the calibration data may need to be updated to align with the laser beams of the other optical assemblies. Here, the master laser beam may be output at a particular point on the build area. The first beamlet, or an imaging sensor of the first beamlet, may determine how the first galvo mirror and the second galvo mirror are to be steered to align with the particular point. The first beamlet may determine how to adjust the galvo mirrors to direct its laser beam to the particular point on the build area. For example, the first galvo mirror may have to be steered to a third position, different than the first position, and/or the second galvo mirror may have to be steered to a fourth position, different than the second position. These updates may be used to generate the alignment correction table. The lens(es), or their position, may similarly be updated. This process ensures that all beamlets can steer the laser beams to the same location on the build area. The same may occur for a second beamlet, a third beamlet, etc., to align the beamlets.

The alignment of the beamlets may be used to ensure that when the laser beams are instructed to melt powder metal at a certain “point” on the build area, all the beamlets across the optical assemblies agree on where that “point” is on the build area. In some instances, the beamlets may be aligned within certain “operational tolerances,” such as ten microns (e.g., the beamlets agree to within ten microns where the “point” is on the build area). However, depending on the precision or resolution of the part to be manufactured, the operational tolerances may be larger or smaller than ten microns (e.g., three microns, 5 microns, 20 microns, etc.). The imaging sensor of the optical assemblies includes a sufficient pixel resolution to image the laser beam with this accuracy.

In some instances, not all beamlets across the optical assemblies may be instructed to image the master laser beam output by the master laser. Instead, calibrating one of the beamlets with the master laser beam may be used to calibrate another beamlet. This may be made possible by knowing the relationship or relative location of the beamlets to one another or the association of beamlets to one another. For example, a first beamlet may be used to image the master laser beam to output by the master laser, and a second beamlet, although not imaging the master laser beam, may know its location relative to the first beamlet. The alignment correction data for the first beamlet may be used to generate alignment correction data for the second beamlet. As such, only a subset of the beamlets may image the master laser beam output by the master laser for use in aligning the beamlets.

In some instances, the master laser is selected using a round-robin approach and/or voting scheme. Moreover, the master laser, or multiple master lasers, may output master laser beams at different points within the build area, and each time, the other optical assemblies may determine corrections to their respective calibration data and/or generate alignment correction tables. For example, at a first instance in time, the master laser may output a master laser beam at a first location on the build area. The imaging sensors of the other beamlets may then image the master laser beam via the galvo mirror(s) and/or the lens(es) adjusting their position. At a second instance in time, the master laser may output the master laser beam at a second location. Therein, the imaging sensors of the beamlets may then image the master laser beam via the galvo mirror(s) and/or the lens(es) adjusting their position. This process may be repeated at various locations on/across the build area or different X and Y locations in the build area. The position of the galvo mirror(s) and/or the lens(es) is recorded to generate the alignment correction table that indicates the particular positions of the galvo mirror(s) and/or the lens(es) for each beamlet to direct their laser beams throughout the build area. The master laser selected at the first instance in time and the second instance in time may be similar or different. In some instances, the lasers may cycle through or take turns being the master laser. Moreover, multiple master lasers may be selected to increase redundancy and reduce error.

In some instances, the third stage of the laser alignment may be performed before, during, and/or after manufacturing a part using the 3D printing system. For example, when commissioning an optical assembly (e.g., replacement, first installation, etc.), the third stage of the alignment process may be performed. The alignment process may also be performed after completion of a print job or part, before commencing a new print job or part, after manufacturing a certain number of layers on a part, after a certain amount of run time, etc. For example, the laser beams may drift over time and need to be realigned. Here, for example, the third stage of the alignment process may be performed between manufacturing layers of a part to ensure that the beamlets are all aligned. In some instances, the third stage may be performed after detecting an error within the 3D printing system, or when the laser beams deviate from their intended location by a specific amount. For example, if laser beams are not accurately being directed to certain points on the build area, as determined by the imaging beams, the 3D printing system may perform the alignment process.

The master laser may direct the master laser beam to points in the build area. These points, or more generally, locations, may be spread across or throughout the build area (e.g., at corners, edges, middle, sides, etc.) to determine alignment correction tables across a wide range of locations where the laser beams are steerable. The points may also be selected based on the parts being manufactured so that the alignment process does not interfere with a part being manufactured. For example, the points for aligning the beamlets may be located on a portion of the build area that is not being melted (i.e., outside a layer of a part). Any number of points may be selected to ensure that the beamlets are aligned (e.g., one, three, four, etc.).

In some instances, the optical assemblies may be instructed to observe fiducials on the build module. These fiducials may be used to confirm that the master laser is correctly aligned on the build module, and that when instructed to steer its laser beam on the build area to a particular point to manufacture a part, that the particular point (within specific operational tolerances) is indeed a correct point that the part is being manufactured. In some instances, when imaging the fiducial, if a correction needs to be applied, that correction may be propagated throughout the rest of the optical assemblies. In an embodiment, as part of the round-robin approach to select a master laser, multiple imaging sensors may image the fiducial, and the optical assembly with the least amount of correction may be chosen as the master laser.

In some instances, alignment may occur in situ, while the part is being manufactured, and/or while a particular beamlet is not generating a laser beam. For example, beamlets that are not actively being used to manufacture a portion of the part may watch and observe other laser beams on the build area. During this observation, the galvo mirror(s) and/or lens(es) may adjust such that images of the melt pool are obtained and in focus. This may be used to apply corrections to the calibration data to generate the alignment correction table. As such, even though a particular beamlet is not outputting a laser beam, it may determine how it would have to steer the galvo mirror(s) and/or lens(es) to direct its laser beam to that point. This ensures that if called upon to perform a lasing task, the beamlet can accurately steer the laser beam to the locations on the build area.

Furthermore, passive beamlets that are not being used to melt powdered metal may observe the other laser beams to determine any errors. For example, the passive beamlets may determine whether the laser beams are melting the powdered metal at the proper location, within specific tolerances, etc. For a given lasing task, these passive lasers may provide imaging beams to the 3D printing system that, in turn, may determine whether the laser beams are at the proper location.

As described herein, the alignment process may increase accuracies within additive manufacturing. For example, while beamlets may be calibrated separately, the beamlets need to align with one another such that the beamlets are collectively and individually steerable to the same location within a build area. If the beamlets cannot be steered to the same location, or have different interpretations of where the location is, parts would contain defects. If the beamlets have different interpretations of where a point is on the build area, the beamlets could not be used in coordination to manufacture a part. However, by generating the alignment correction table, the beamlets are steerable to the same location and all of the beamlets concur as to the location on the build area. In addition, by performing at least a portion of the alignment process offline, less time may be taken during the commissioning of the optical assemblies on the lasing module.

Additional details of the lasing modules, the build modules, and/or the 3D printing system are described in, for example, U.S. patent application Ser. No. 17/944,883, filed Sep. 14, 2022, entitled “Lasing Module for 3D Printing System,” U.S. patent application Ser. No. 17/944,901, filed Sep. 14, 2022, entitled “3D Printing System with Moving Build Module,” and/or U.S. patent application Ser. No. 18/101,408, filed Jan. 25, 2023, entitled “Scheduling Lasing Tasks of 3D Printing System,” the entirety of which are herein incorporated by reference.

The present disclosure provides an overall understanding of the principles of the structure, function, device, and system disclosed herein. One or more examples of the present disclosure are illustrated in the accompanying drawings. Those of ordinary skill in the art will understand that the devices and/or the systems specifically described herein and illustrated in the accompanying drawings are non-limiting examples. The features illustrated or described in connection with one example may be combined with the features of other examples. Such modifications and variations are intended to be included within the scope of the appended claims.

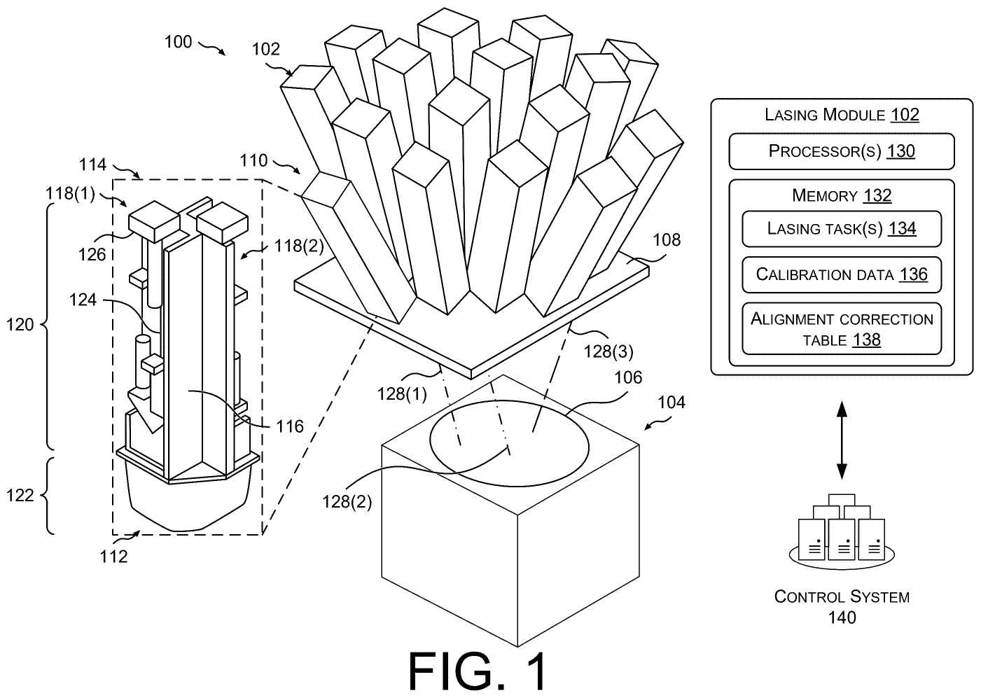

FIG. 1 illustrates an example 3D printing system 100 used to manufacture parts, according to an example of the present disclosure. In some instances, the 3D printing system 100 may include a lasing module 102 and a build module 104. The lasing module 102 is shown residing vertically above (e.g., overhead) the build module 104. The build module 104 may be configured to pass underneath the lasing module 102 such that the lasing module 102 may build parts within a bed of powdered material, such as a build area 106, on the build modules 104, respectively. In FIG. 1, a single of the lasing module 102 and a single of the build module 104 is shown. However, in some instances, the 3D printing system 100 may include more than one of the lasing modules 102 and/or more than one of the build modules 104. In such instances, the lasing modules 102 may build parts on the build module 104 or across the build modules 104. Additionally, the lasing modules 102 may build parts across more than one of the build modules 104.

The lasing module 102 includes a housing 108 (e.g., hood) to which a plurality of the optical assemblies 110 are coupled. The optical assemblies 110 may be respectively coupled to sections of the housing 108. As shown, the optical assemblies 110 may be situated as an array across and about the housing 108 to be oriented towards the build area 106. In some instances, any number of the optical assemblies 110 may couple to the housing 108, or stated alternatively, the lasing module 102 may include any number of the optical assemblies 110. The shape of the housing 108 (or a portion of the housing 108 to which the optical assemblies 110 couple) permits a greater number of the optical assemblies 110 to be coupled to the lasing module 102. For example, a dome-shaped nature of the housing 108 may permit a greater number of the optical assemblies 110 to be coupled to the housing 108.

Additionally, as discussed herein, the optical assemblies 110 themselves may include any number of laser(s) that generate respective laser beams directed towards the build area 106. For example, the optical assemblies 110 may include two lasers, where each of the laser beams generated by the lasers may be independently or collectively (e.g., clustered) steered (e.g., via galvo mirror(s)) towards the build area 106. As such, the lasers may be individually and collectively used when manufacturing parts on the build area 106. Additionally, lens(es) of the optical assemblies 110 may control a spot size of the laser beams on the build area 106. An optical pathway of the laser beams may be modified to respectively steer the laser beam toward selective portions of the build area 106 to melt powdered metal, thus creating melt pools at the selected portions of the build area 106. Once cooled or solidified, the melt pool(s) create a part (or a structure of the part).

A detailed view of the optical assembly 110 is shown in FIG. 1. The optical assembly 110 may include a first end 112 that couples to the housing 108 and a second end 114 spaced apart from the first end 112. In some instances, the second end 114 may include various connectors (e.g., fiber, Ethernet, etc.) for receiving commands or instructions associated with controlling an operation (e.g., lasing tasks) of the optical assembly 110 (e.g., laser beam energy, laser beam width, etc.). The optical assembly 110 includes a frame 116 to which components of the optical assembly 110 couple.

The optical assembly 110 may include one or more beamlets 118, where a first beamlet 118(1) may be disposed on a first side, surface, etc., of the frame 116, and a second beamlet 118(2) may be disposed on a second side, surface, etc., of the frame 116. In some instances, the lasing module 102 may include sixteen of the optical assemblies 110, where each of the optical assemblies 110 may include two of the beamlets 118. However, the lasing module 102 may include more than sixteen of the optical assemblies 110, and/or the optical assemblies 110 themselves may include more than or less than two of the beamlets 118.

In some instances, the beamlets 118 may each include a laser delivery and imaging subassembly 120 and a focusing and steering subassembly 122. The laser delivery and imaging subassembly 120 may be responsible for generating laser beams by a laser 124 that is directed towards the build area 106. The laser delivery and imaging subassembly 120 also transmits images of a melt pool towards an imaging sensor 126. Each of the beamlets 118 may include the laser 124 for generating a laser beam and the imaging sensor 126 configured to receive an imaging beam. That is, respective beamlets 118 may have components for directing a respective laser beam to the build area 106 and components for imaging the laser beam. Although the laser delivery and imaging subassembly 120 and the focusing and steering subassembly 122 are described as separate components, in some instances, the laser delivery and imaging subassembly 120 and the focusing and steering subassembly 122 may be embodied within a single assembly.

The focusing and steering subassembly 122 serves to focus and steer the laser beams emitted by the laser 124 and imaging beams received by the imaging sensors 126. For example, the focusing and steering subassembly 122 may include various galvo mirror(s) and/or lens(es) that direct the laser beams towards the build area 106. The galvo mirror(s) and/or lens(es) may also direct imaging beams towards the imaging sensor 126. The laser delivery and imaging subassembly 120 may image a melt pool associated with the laser beam of the beamlets 118, other melt pools associated with other laser beams of other beamlets 118 (e.g., of another optical assembly 110), fiducials on the build module 104 or build area 106, etc. As will be discussed herein, the laser delivery and imaging subassembly 120 may image the build area 106 while the laser of the beamlets 118 are lasing (i.e., outputting laser beams), or while the laser 124 of the beamlets 118 is/are not lasing. In some instances, the beamlets 118 may image the master laser beam simultaneously.

The imaging beam(s) represent thermal imaging data of the melt zone (e.g., where the powdered metal is melted) by the laser beams in the build area 106. Image(s) captured by the imaging sensor 126 are used to detect the melt zone, such as a location, heat, intensity, stress, strain, etc., of the melt zone. The image(s), or generally, data, may be used to determine whether the manufacturing process is successful (e.g., producing parts without defects and with correct structures). For example, laser beam location, power, focus, and speed may be adjusted based on analyzing the image(s) of the melt pool. The image(s) may also be used to determine how the melt pool deviates from an expected location (e.g., shift, growth, etc.) during manufacturing.

The image(s) captured by the imaging sensor 126 may also be used to calibrate and align the beamlets 118 across the optical assemblies 110. For example, as each of the lasers 124 may steer their laser beams to locations on the build area 106, it is important that the lasers 124 are referenced to the same locations on the build area 106 or agree on the locations within the build area 106. That is, as each of the lasers 124 may individually or collectively melt powdered metal on the build area 106, to ensure part quality, the lasers 124 need to be referenced to the same location of points on the build area 106.

Take, for example, where a particular layer of a part is being manufactured on the build area 106 from three lasers. In FIG. 1, each of the three lasers may generate a laser beam. For example, a first laser of a first beamlet may generate a first laser beam 128(1), a second laser of a second beamlet may generate a second laser beam 128(2), and a third laser of a third beamlet may generate a third laser beam 128(3) directed to the build area 106. All of the lasers 124, however, need to be in agreement as to the location of certain “points” on the build area 106 in order to accurately manufacture the part. That is, to ensure that the part is accurately manufactured, or within certain tolerances, the lasers 124 need to agree on where points are located within the build area 106.

In some instances, the location of points may be expressed in a coordinate system (e.g., X,Y locations). For example, the build area 106 may be associated with a coordinate system, where lasing tasks may be performed at coordinate locations within the coordinate system. The first laser beam 128(1) may perform a lasing task at a first location (e.g., X1,Y1) on the build area 106, the second laser beam 128(2) may perform a lasing task at a second location (e.g., X2, Y2) on the build area 106, and the third laser beam 128(3) may perform a lasing task at a third location (e.g., X3, Y3) on the build area 106. If the lasers 124 are not aligned with one another, and therefore have different references in coordinate space (e.g., where X1,Y1 is, where X2, Y2 is, where X3, Y3 is, etc.), the part will not be accurately manufactured. In other words, each of the lasers 124 need to be aligned on the same coordinate system, for example, such that each of the lasers 124 understand and agree where the first location, the second location, and the third location are located at on the build area 106. This is true regardless of whether the lasers 124 are collectively steered to the same location or different locations. Although described as aligning three of the lasers 124, the laser(s) 124 across any number of the optical assemblies 110 may be aligned. Moreover, the lasers 124 may be within the same or different optical assembly 110.

In some instances, the alignment of the lasers 124 may include three stages. At a first stage, the laser 124 and the imaging sensor 126 may be aligned. For example, as noted above, individual beamlets 118 include the laser 124 and the imaging sensor 126. The first stage may involve testing, validating, and qualifying that the lens(es) can focus the laser beam to different spot sizes. Throughout their range of spot sizes, the imaging sensor 126 may be tuned to image the laser beams. At the first stage, the laser beam and the imaging beam may be aligned in that the imaging sensor 126 is aligned to image the laser beam generated by the laser 124.

At a second stage, the beamlets 118 may be calibrated with the galvo mirror(s). For example, the galvo mirror(s) may be moveable over a range of distances, and different combinations of steering the galvo mirror(s) may be achieved to direct the laser beam to particular points within the build area 106. In some instances, a grid, coordinate system, or other set of fiducials on a calibration map may be used to calibrate the galvo mirror(s). The galvo mirror(s) may be actuated over a range of positions to understand the position of each galvo mirror that is needed to steer the lasers and image the locations on the calibration map. As the galvo mirror(s) are moved, the imaging sensor 126 may image the points on the grid to understand how the galvo mirror(s) are actuated to image a particular point on the calibration map. Since the imaging sensor 126 has been previously aligned with the laser 124, at the first stage, the laser beam may not need to be actuated to understand where the laser beam will be directed at particular positions of the galvo mirror(s).

In some instances, the calibration map may represent an X-Y coordinate system, and the galvo mirror(s) may be actuated to various positions for the imaging sensor 126 to image the locations on the X-Y coordinate system. As an example, to direct the laser beam to X1, Y1 on the coordinate map, the positions of the galvo mirror(s) may be recorded, to direct the laser beam to X2, Y2 on the coordinate map, the positions of the galvo mirror(s) may be recorded, and so forth. As the galvo mirror(s) are steered, the positions of the galvo mirror(s) are recorded, and calibration data (e.g., a calibration table) is generated.

At a third stage, the individual beamlets 118 may be aligned with one another. Aligning the beamlets 118 ensures that the beamlets 118 are each oriented within the same coordinate space on the build area 106. For example, as introduced above, to manufacture a part, laser(s) from the optical assemblies 110 may be instructed to steer their laser beams to particular points on the build area 106. If the beamlets 118 are not aligned, the beamlets 118 are not “looking” at the same point on the build area 106 and parts may be incorrectly manufactured. In some instances, at the third stage, one of the lasers 124 may be selected as a master laser that generates a laser beam on the build area 106. The other beamlets 118 may locate the master laser beam generated by the master laser. As the other beamlets 118 locate the laser beam, imaging beams of the master laser beam may be received by the imaging sensors 126 across the beamlets 118. By imaging the master laser beam, the location of the master laser beam on the build area 106 is determined, and such location may be used to recalibrate the calibration data. For example, locations, orientations, etc., of the mirror(s) and/or the lenses may be recorded to recalibrate the beamlets 118. This may involve an update to the calibration data of the lasers 124, or the generation of an alignment correction table. In some instances, the calibration data may be organized within a calibration table, where the calibration table indicates the steering, or position, of the mirror(s) and/or the lens(es) to direct a laser beam to a location on a build area and/or to image the location on the build area.

In some instances, the first stage and/or the second stage may be performed offline. In some instances, the third stage may be performed before, during, and/or after manufacturing of a part using the 3D printing system 100. For example, when commissioning an optical assembly 110, the third stage may be performed. The alignment process may also be performed after completion of a print job or part, before commencing a new print job or part, after manufacturing a certain number of layers on a part, after a certain amount of run time, etc. For example, over time, the laser beams may drift and need to be realigned with one another.

The build modules 104 include containers (e.g., drums, bins, etc.) within which parts are manufactured. In some instances, each of the containers includes the build area 106 within which parts are manufactured. In some instances, the laser(s) 124 within the optical assemblies 110 may be capable of reaching all points within the build area 106.

The lasing module 102 is shown including processor(s) 130 and memory 132, where the processor(s) 130 may perform various functions and operations associated with performing lasing tasks 134, aligning the beamlets 118, etc., and the memory 132 may store instructions executable by the processor(s) 130 to perform the operations described herein. For example, the processor(s) 130 may control the laser delivery and imaging subassembly 120 and the focusing and steering subassembly 122. The memory 132 may store calibration data 136 as generated from the first stage and/or the second state of the laser alignment. The memory 132 may also store an alignment correction table 138 in association with each of the beamlets 118, as generated from the third stage of the laser alignment. In some instances, the calibration data 136 and the alignment correction table 138 may be generated via imaging beams received by the imaging sensors 126. Additional details of the calibration data 136 and the alignment correction table 138 are discussed herein.

The lasing module 102 may be in communication with a control system 140, which may be responsible for instructing the lasing module 102, and therefore the optical assemblies 110, as to the parts being manufactured. For example, the control system 140 may instruct the lasing module 102 to perform the lasing tasks 134 within the build area 106. The control system 140, or the lasing module 102, may determine when to perform the lasing task 134, which of the laser(s) 124 are to perform the lasing task 134, as well as specifics associated therewith (e.g., lasing power, location, etc.). The control system 140 may also perform laser alignment. For example, the control system 140 may receive data associated with the imaging beams captured across the imaging sensors 126 for determining whether the beamlets 118 are aligned. In some instances, the control system 140 may determine corrections to the calibration data 136 after the laser alignment process.

Although certain processes are described as being performed by the lasing module 102 and/or the control system 140, the lasing module 102 and/or the control system 140 may perform different processes. Further, the beamlets 118 may perform additional or alternative processes, and/or may determine, for example, the calibration data 136 and/or the alignment correction tables 138.

As used herein, a processor, such as the processor(s) 130 may include multiple processors and/or a processor having multiple cores. Further, the processor(s) 130 may comprise one or more cores of different types. For example, the processor(s) 130 may include application processor units, graphic processing units, and so forth. In one implementation, the processor(s) 130 may comprise a microcontroller and/or a microprocessor. The processor(s) 130 may include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 130 may possess its own local memory, which also may store program components, program data, and/or one or more operating systems.

Memory, such as the memory 132 may include volatile and nonvolatile memory, removable and non-removable media implemented in any method or technology for storage of information, such as computer-readable instructions, data structures, program component, or other data. Such memory may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The memory may be implemented as computer-readable storage media (“CRSM”), which may be any available physical media accessible by the processor(s) to execute instructions stored on the memory. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other tangible medium which can be used to store the desired information and which can be accessed by the processor(s) 130. The memory 132 is an example of non-transitory computer-readable media. The memory 132 may store an operating system and one or more software applications, instructions, programs, and/or data to implement the methods described herein and the functions attributed to the various systems.

In some instances, the control system 140 may be implemented as one or more servers and may, in some instances, form a portion of a network-accessible computing platform implemented as a computing infrastructure of processors, storage, software, data access, etc., that is maintained and accessible via a network such as the Internet. The control system 140 does not require end-user knowledge of the physical location and configuration of the system that delivers the services. Common expressions associated with the control system 140 include “on-demand computing”, “software as a service (SaaS)”, “platform computing”, “network-accessible platform”, “cloud services”, “data centers”, etc.

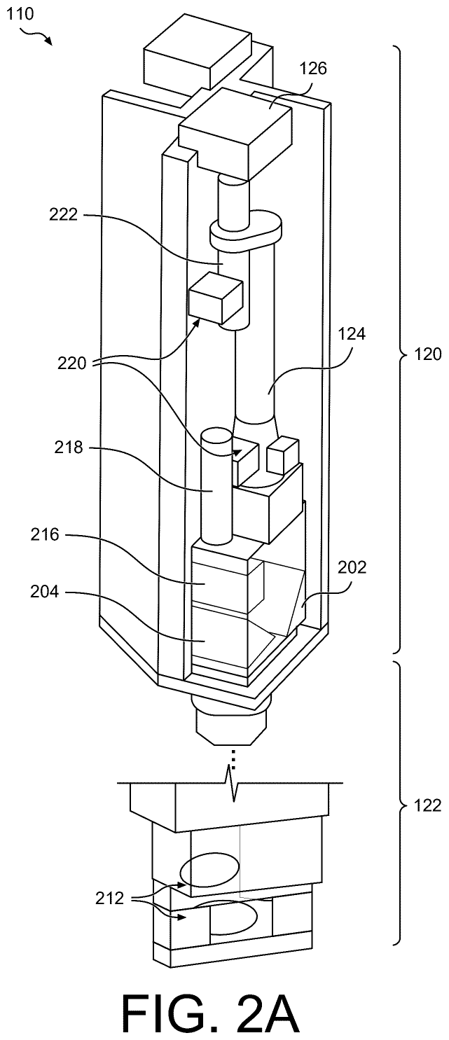

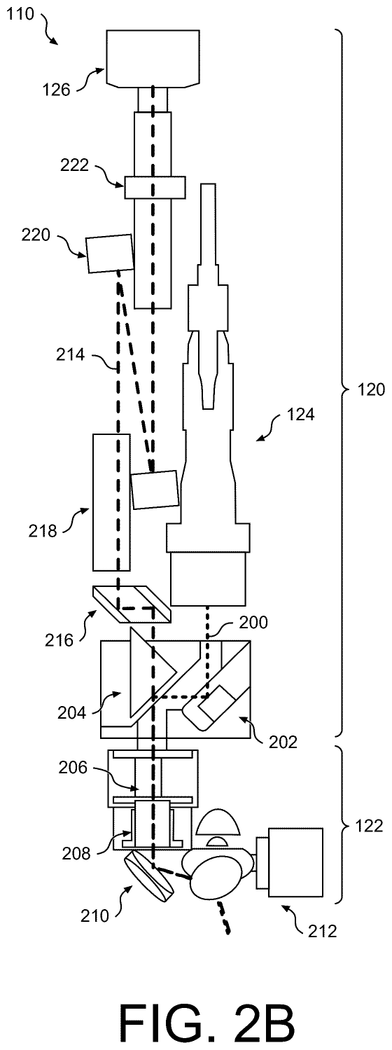

FIGS. 2A and 2B illustrate details of the optical assemblies 110, according to an example of the present disclosure. The optical assembly 110, in some instances, includes the laser 124 (as introduced above), a laser mirror 202, a dichroic mirror 204, one or more expander lens(es) 206, one or more objective lens(es) 208, a turning mirror 210, and galvo mirror(s) 212. The laser 124 may represent a collimated laser that generates a laser beam 200 having a low beam divergence. As introduced above, the laser beam 200 generated by the laser 124 is directed towards the build area 106 via the various mirror(s) and/or lens(es) of the optical assembly 110.

As the laser beam 200 is emitted by the laser 124, the laser mirror 202 steers the laser beam 200 to the dichroic mirror 204. The laser mirror 202 may represent a turning mirror that turns the direction of the laser beam 200 by 90 degrees. The dichroic mirror 204 reflects the laser beam 200 towards the one or more expander lens(es) 206 and the one or more objective lens(es) 208. The dichroic mirror 204 reflects the laser beam 200 while being transmissive to other light of different wavelengths. For example, the dichroic mirror 204 may be reflective to wavelengths above 1000 microns, but may be transmissive to wavelengths below 1000 microns.

In some instances, the one or more expander lens(es) 206 and/or the one or more objective lens(es) 208 may be collectively referred to as a focus control lens that focuses a spot size associated with the laser beam 200. A focus controller may change a working distance, field, and spot size of the laser beams 200 by translating the one or more expander lens(es) 206 and/or the one or more objective lens(es) 208 along a length of the laser beam 200 (e.g., longitudinally). In doing so, the one or more expander lens(es) 206 and/or the one or more objective lens(es) 208 have an adjustable position along the path of the laser beam 200 to change the resulting focal length.

The one or more expander lens(es) 206 may first receive the laser beam 200 from the dichroic mirror 204. The one or more expander lens(es) 206 may increase a diameter of the laser beam 200. Therein, the laser beam 200 is transmitted to the one or more objective lens(es) 208. After passing through the one or more expander lens(es) 206 and the one or more objective lens(es) 208 (or the focus control lens), the turning mirror 210 directs the laser beam 200 towards the galvo mirror(s) 212. In some instances, the positioning of the turning mirror 210 directs the laser beam 200 perpendicularly towards the galvo mirror(s) 212. The galvo mirror(s) 212 generally represents a single axis steering mirror. The galvo mirror(s) 212 may include a first galvo mirror and a second galvo mirror, where each of the galvo mirror(s) 212 is independently operable to steer the laser beams 200 (e.g., via one or more motors) about a single axis. Therefore, in combination, the galvo mirror(s) 212 may have two axis steering.

The optical assembly 110 may further include components for imaging the melt pool produced by the laser beam 200, a melt pool generated by another laser beam 200 (from a different optical assembly 110), and/or points for being calibrated and/or aligned. The imaging sensor 126 may represent a high-speed camera. Images from the imaging sensor 126 are used to determine a size (e.g., area) and/or shape (e.g., aspect ratio) of the melt pool, or other characteristic(s) of the melt pool, such as a thermal signatures, gradients, or profiles. These image(s) may be analyzed (e.g., via the processor(s) 130, the control system 140, etc.) to determine a location of the melt pool on the build area 106, for example, in coordinate space. Knowing the location of the melt pool, the lasers 124 may be steered accordingly and/or adjustments may be made to create the melt pools at desired locations. For example, knowing the location of the melt pool allows the beamlets 118 to control (e.g., steer) their respective laser delivery and imaging subassembly 120. As will be discussed herein, the beamlets 118 may include, or be associated with, the calibration data 136 that indicate positions of the focusing and steering subassembly 122 (e.g., the galvo mirror(s) 212 and/or lens(es)) for directing the laser beams 200 to specific locations on the build area 106. For example, certain positions of the galvo mirror(s) 212 and/or the lens(es) may steer the laser beams 200 to specific locations on the build area 106.

In some instances, some or all of the components discussed above that steer the laser beam 200 onto the build area 106 may further be used to enable the imaging sensor 126 to image the melt pool, points on a calibration map to calibrate the beamlet 118, datums/fiducials on the build area 106, and so forth. For example, the dichroic mirror 204 may reflect the laser beam 200, while transmitting certain wavelengths of light onto the imaging sensor 126 via imaging beams 214. Therefore, in some instances, the laser beam 200 and imaging beams 214 transmitted to the imaging sensor 126 may be substantially parallel over at least portions of their paths within the optical assembly 110. For example, to reach the imaging sensors 126, the imaging beams 214 may traverse a path substantially parallel to a path of a laser beam 200 through at least a portion of the optical assembly 110. In some instances, the path of the laser beam 200 and the path of the imaging beam 214 may be parallel, but in opposite directions. However, the imaging sensor 126 is configured to receive imaging beams 214 generated by lasers 124 of other optical assemblies 110. In such instances, for a particular beamlet 118, the imaging sensor 126 may receive imaging beams 214 from another beamlet 118, while the laser beam 200 of the particular beamlet 118 is not being generated.

To steer and focus light towards the imaging sensor 126, the optical assembly 110 may include a periscope mirror 216, a doublet focus lens 218, a fold mirror pair 220, and/or a liquid dynamic lens 222. Such components may permit the imaging sensor 126 to image the melt pool. Additionally, such components focus the light (e.g., in focus) towards the imaging sensor 126.

In some instances, the laser 124, the imaging sensor 126, the laser mirror 202, the dichroic mirror 204, the fold mirror pair 220, periscope mirror 216, the doublet focus lens 218, and the liquid dynamic lens 222 make up or represent components of the laser delivery and imaging subassembly 120. In some instances, the galvo mirror(s) 212, the turning mirror 210, the one or more objective lens(es) 208, and/or the one or more expander lens(es) 206 make up or represent components of the focusing and steering subassembly 122.

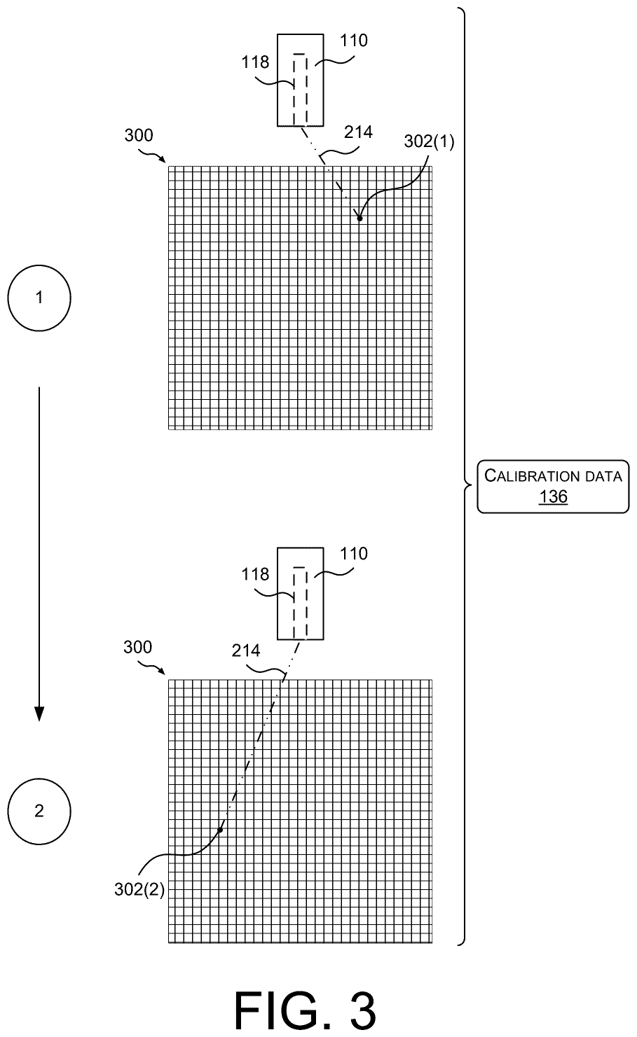

FIG. 3 illustrates an example scenario for generating calibration data 136 for a beamlet 118 of an optical assembly 110, according to an example of the present disclosure. In some instances, each of the beamlets 118 across the optical assemblies 110 may include the calibration data 136, where the calibration data 136 indicate positions of the galvo mirror(s) 212 and/or the lens(es), for example, to direct and/or focus the laser beam 200 to a particular points (with certain operational tolerances). For example, to steer the laser beams 200 to particular locations within the build area 106, the galvo mirror(s) 212 may be positioned and/or the lens(es) may be adjusted accordingly. Moreover, to receive the imaging beams 214 from different locations across the build area 106, the galvo mirror(s) 212 may be positioned and/or the lens(es) may be adjusted accordingly. In some instances, the processor(s) 130 of the lasing module 102 may generate the calibration data 136, the control system 140 may generate the calibration data 136, processor(s) of the beamlets 118 may generate the calibration data 136, etc.

As part of generating the calibration data 136, the galvo mirror(s) 212 may be steered to particular positions and/or the lens(es) adjusted such that the imaging sensor 126 images a calibration map 300. The calibration map 300 may include any number of the points 302 (e.g., thousands, tens of thousands, etc.). When generating the calibration data 136, the galvo mirror(s) 212 may be steered to certain positions and/or the lens(es) adjusted such that the imaging sensor 126 is able to view a plurality of points 302 on the calibration map. As the imaging sensor 126 views the points 302 on the calibration map 300, the position(s) of the galvo mirror(s) 212 and/or the lens(es) may be recorded. This enables the laser beam 200 to be steered to particular locations in coordinate space, for example, given the various positions of the galvo mirror(s) 212 and the lens(es). In some instances, the laser beam 200 may not be output while generating the calibration data 136.

By way of illustration, at “1” in FIG. 3, the imaging sensor 126 may image a first point 302(1) on the calibration map 300. The imaging sensor 126 may receive an imaging beam 214 indicating the first point 302(1), and the optical assembly 110 (or the beamlet 118) may record the position of the galvo mirror(s) 212 and the lens(es) in order to image the first point 302(1). Although the laser beam 200 is not output during this stage, because the laser beam 200 and the imaging beam 214 share a portion of the same path through the beamlet 118, the positions of the galvo mirror(s) 212 and the lens(es) may be used subsequently to control and steer the laser beams 200. In some instances, prior to utilizing the calibration map 300, the laser beam 200 and the imaging beam 214 may be aligned (e.g., the forward path and inverse path), meaning, that the imaging sensor 126 is aligned to image the laser beam 200 generated by the laser 124.

At “2” in FIG. 3, the imaging sensor 126 may image a second point 302(2) on the calibration map 300, where the second point 302 2) is different than the first point 302(1). Similar to the first point 302(1), the imaging sensor 126 may receive an imaging beam 214 indicating the second point 302(2), and the optical assembly 110 (or the beamlet 118) may record the position of the galvo mirror(s) 212 and the lens(es). This process of imaging the points 302 on the calibration map 300 may repeat for any number of the points 302 across a field of view of the imaging sensor 126, or locations that are capable of being reached by the laser beam 200. While FIG. 3 illustrates the imaging of two of the points 302 on the calibration map 300, any number of the points 302 may be imaged for generating the calibration data 136. The calibration data 136 may, in some instances, indicate the positions of the galvo mirror(s) 212 and the lens(es) to steer the laser beam 200 to certain locations across the build area 106. This data may in turn be used when performing the lasing tasks 134, for example, to understand how to control the galvo mirror(s) 212 and and/or the lenses for steering the laser beam 200 to locations across the build area 106. Moreover, the calibration data 136 may, in some instances, indicate the positions of the galvo mirror(s) 212 and the lens(es) to receive the imaging beam 214 from certain locations across the build area 106. Each of the beamlets 118 are associated with the calibration data 136 that indicates how the galvo mirror(s) 212 and/or the lens(es) are positioned to steer the laser beams 200 to respective positions (e.g., X, Y coordinates) across the build area 106.

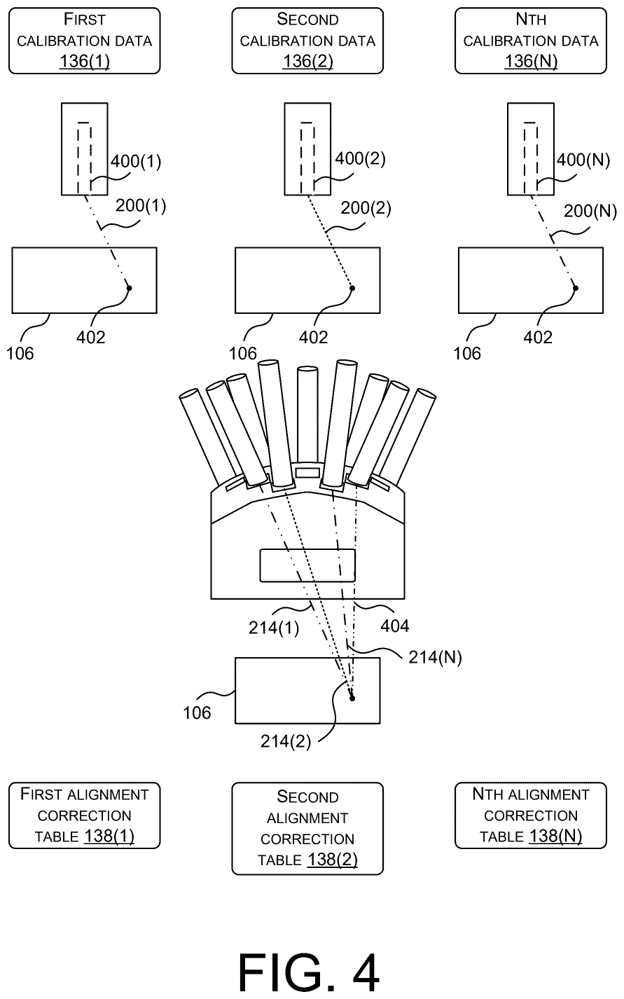

FIG. 4 illustrates an example of generating the alignment correction tables 138 for the beamlets 118, according to an example of the present disclosure. As introduced above, each of the beamlets 118 has the calibration data 136, where the calibration data 136 indicates positions of the galvo mirror(s) 212 and/or the lens(es) to steer the laser beam 200 and/or direct the imaging beams 214 to the imaging sensor 126. However, when attached to the lasing module 102 the beamlets 118 across the optical assemblies 110 need to be aligned with one another such that the beamlets 118 are referenced to the same points on the build area 106. That is, while each of the beamlets 118 may have the calibration data 136, each of the beamlets 118 may have a different calibration, meaning, that when installed on the lasing module 102, their “points” may not exactly match (i.e., align) in coordinate space.

For example, the beamlets 118 may not be calibrated to the same points on the build area 106. To compensate for this, the beamlets 118 may be aligned with one another prior to performing the lasing tasks 134 on the build area 106. This ensures that each of the beamlets 118 are looking at the same points on the build area 106 and that the beamlets 118 reference the same coordinate system. In some instances, the calibration data 136 may be used to steer the laser beams 200 to within a certain accuracy (e.g., within 100 microns), while the alignment correction tables 138 be used to steer the laser beams 200 to within a higher accuracy (e.g., within 10 microns).

A first beamlet 400(1) may have first calibration data 136(1), a second beamlet 400(2) may have second calibration data 136(2), and a nth beamlet 400(N) may have nth calibration data 136(N). The calibration data 136 may be generated, for example, as discussed above with regard to FIG. 3. For example, to direct the laser beams 200(e.g., a first laser beam 200(1), a second laser beam 200(2), an nth laser beam 200(N)) to a first point 402 on the build area 106, the first beamlet 400(1) may have a first steering, the second beamlet 400(2) may have a second steering, and the nth beamlet 400(N) may have an nth steering. However, each of the first beamlet 400(1), the second beamlet 400(2), and the nth beamlet 400(N) may have a different indication of where the first point 402 is on the build area 106. That is, while each of the first beamlet 400(1), the second beamlet 400(2), and the nth beamlet 400(N) may steer the laser beams 200 towards the first point 402, the first points 402 may not align within a desired accuracy, or the first beamlet 400(1), the second beamlet 400(2), and the nth beamlet 400(N) may have a different understanding of where the first point 402 is on the build area 106. As such, the first point 402, although intended to be the same location on the build area 106, may not be the same. The generation of the alignment correction tables 138 (e.g., a first alignment correction table 138(1), a second alignment correction table 138(2), and an nth alignment correction table 400(N)) ensures that each of the first beamlet 400(1), the second beamlet 402(2), and the third beamlet 402(3) agree as to where the first point 402 is in coordinate space within a ten micron accuracy, for example.

In some instances, to generate the alignment correction tables 138, one of the lasers 124 of the beamlets 118 may be selected as a master laser and output a master laser beam 404 on the build area 106. In some instances, the master laser may be selected via a round-robin approach. Each of the beamlets 118 may then steer their galvo mirror(s) 212 and/or lens(es) to align with a location of the master laser beam 404 on the build area 106. Steering the galvo mirror(s) 212 and adjusting the lens(es) enables the imaging beams 214 to be received by the first beamlet 400(1), the second beamlet 400(2), and the nth beamlet 400(N). For example, a first imaging sensor of the first beamlet 400(1) may receive a first imaging beam 214(1), a second imaging sensor of the second beamlet 400(2) may receive a second imaging beam 214(2), and a nth imaging sensor of the nth beamlet 400(N) may receive a nth imaging beam 214(N). If the imaging beams 214 are not aligned with a location of the master laser beam 404 on the build area 106, the galvo mirror(s) 212 and/or lens(es) may be adjusted accordingly. Adjustment may continue until the imaging beams 214 are within a certain accuracy of the master laser beam 406 (e.g., 10 micros). As each of the imaging beams 214 are aligned with the laser beams 200, for example, at the first stage, aligning of the imaging beams 214 enables the beamlets 118 to steer the laser beams 200 to a corresponding location on the build area 106. However, by aligning the imaging beams 214 with the master laser beam 404, this ensures that all of the beamlets 118 are aligned, calibration, referenced, etc., to the same points across the build area 106. In some instances, the beamlets 400 may image the master laser beam 404 simultaneously.

In some instances, all or a portion of the optical assemblies 110 may be instructed to observe or locate the master laser beam 404. Instead, calibrating one of the beamlets 118 or the optical assemblies 110 with the master laser beam 404 may be used to calibrate another beamlet 118. This may be made possible by knowing the relationship or relative location of the beamlets 118 to one another, or the association of beamlets 118 to one another. For example, the first beamlet 400(1) may be used to image the master laser beam 404, and a fourth beamlet, although not imaging the master laser beam 404, may know its location relative to the first beamlet 400(1). The first alignment correction table 138(1) may be used to generate the alignment correction table for the fourth beamlet. As such, only a subset of the beamlets 118 may image the master laser beam 404.

In some instances, the master laser beam 404 may be moved to different locations across the build area 106. This may calibrate the beamlets 118 across a range of positions on the build area 106. Any number of points on the build area 106 may be selected, and different beamlets 118 may be selected to output the master laser beam 404. Moreover, in some instances, to generate the alignment correction tables 138, before the master laser outputs a master laser beam 404 on the build area 106, the beamlets 118 may be calibrated to the build module 104. For example, the imaging beams 214 may image a grid-based system on the build area 106 (e.g., prior to the powdered metal being deposited), points on a structure of the lasing module 102, etc. This process may be used to identify a height of the build module 104, the build area 106, a location, or position, of the build module 104 to the beamlets, and so forth. The calibration data 136 may be updated during this process based on the imaging beams 214 received. In some instances, the alignment correction tables 138 may be generated before the lasing tasks 134 are performed, during or while the lasing tasks 134 are performed, when an optical assembly 110 is commissioned/installed on the lasing module 102, etc.

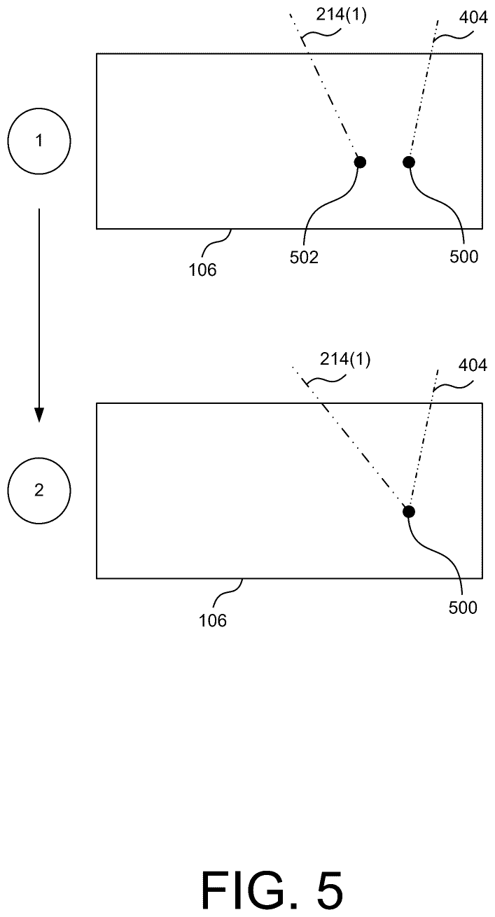

FIG. 5 illustrates a detailed view for generating the alignment correction tables 138, according to an example of the present disclosure. At “1” in FIG. 5, a master laser may direct the master laser beam 404 to a first point 500 (e.g., X1,Y1) on the build area 106. The first beamlet 400(1), for example, may image the master laser beam 406 at the first point 500. However, the first beamlet 400(1) may be misaligned with the first point 500. In other words, the first calibration data 136(1) of the first beamlet 400(1) may indicate that a second point 502 (e.g., X2, Y1) is the first point 500. That is, the first beamlet 400(1) may have a different indication, or disagree, with the location of the first point 500 on the build area. To align the beamlets 118, the first imaging sensor of the first beamlet 400(1) may receive the first imaging beam 214(1) and understand that the first beamlet 400(1) is misaligned with the master laser beam 404. A correction may be applied to the first calibration data 136(1) to generate the first alignment correction table 138(1), where the first alignment correction table 138(1) indicates the positions of the galvo mirror(s) 212 and/or lens(es) to direct a laser beam 200 of the first beamlet 400(1) to the first point 500. In doing so, by applying a correction, at “2” in FIG. 5, the beamlets 118 may agree on the location of the first point 500. During performance of the lasing tasks 134, the beamlets 118 or the lasers 124 of the beamlets 118 may be steerable to the same location (or within a certain tolerance).

This process may occur for other beamlets 118, whereby the other beamlets 118 may receive the imaging beams 214 and determine whether they are aligned or misaligned with the master laser beam 404. In some instances, not all of the beamlets 118 may image the master laser beam 404. Instead, the beamlets 118 may be associated with one another, and generating the alignment correction table 138 for one of the beamlets 118 may be used to generate an alignment correction table 138 for another of the beamlets 118 that is not imaging the master laser beam 404. Additionally, while FIG. 5 illustrates directing the master laser beam 404 to the first point 500, the master laser beam 404 may be directed to other points on the build area 106, and the imaging beams 214 may be used to generate additional corrections within the alignment correction tables 138.

FIG. 6 illustrates examples points on the build area 106 to align the beamlets 118, according to an example of the present disclosure. The build area 106 is shown including, or having, the lasing tasks 134. Each of the lasing tasks 134 may represent an area, portion, section, etc., on the build area 106 in which powdered metal is melted to form layers of a part. The lasers 124 across the optical assemblies 110 may be instructed, and steered, to perform the lasing tasks 134.

In some instances, before, during, or after the lasing tasks 134 are performed, the beamlets 118 may be aligned with one another to ensure that the beamlets 118 are being steered, or capable of being steered, to the same location on the build area 106. For example, the master laser may output the master laser beam 404 at a first point 600(1) on the build area 106 (e.g., X1,Y1). Each of the beamlets 118 may position their galvo mirror(s) 212 and/or lens(es) in order receive an imaging beam 214 at the first point 600(1) for generating the alignment correction tables 138. The master laser may then output the master laser beam 404 at a second point 600(2) on the build area 106 (e.g., X2,Y2) and each of the beamlets 118 may position their galvo mirror(s) 212 and/or lens(es) in order receive an imaging beam 214 at the second point 600(2). This process may repeat for any number of points, such as a third point 600(3), a fourth point 600(4), and a fifth point 600(5). The points 600 may be located throughout, within, on, etc., the build area 106. For example, the fifth point 600(5) is shown being within approximately a center of the build area 106. However, the locations of the points 600 within the build area 106 may not interfere with the lasing tasks 134, or a location of the lasing tasks 134 within the build area 106.

The master laser is selected to direct the master laser beam 404 to a particular point within the build area 106. Therein, all of the beamlets 118 direct the imaging sensors 126, via the galvo mirror(s) 212 and/or lens(es), to look at the particular point. The beamlets 118 then determine, via the imaging beams 214, how to correct their galvo mirror(s) 212 and/or lens(es) to be looking at the particular point within a certain operational tolerance (e.g., 10 microns). This process is repeated throughout the build area 106 for different X and Y locations, for example, to apply corrections to the calibration data 136 and generate the alignment correction table 138. Doing so ensures that each of the beamlets 118 are adjusted to align with the master laser. Each of the beamlets 118 dynamically adjusts the calibration data 136 to agree with each X-Y coordinates of the master laser beam 406 (e.g., via a control system of the beamlet 118).

In some instances, not all of the beamlets 118 may observe the master laser beam 404. In some instances, the beamlets 118 that are not actively being used to manufacture a portion of the part may watch and observe other laser beams on the build area 106. During this observation, the galvo mirror(s) 212 may adjust such that images of the melt pool are obtained via the imaging sensor 126 of those beamlets 118. This in turn may be used to apply corrections to the calibration data 136 for use in generating the alignment correction table 138. Even though a beamlet 118 may not output a laser beam 200, the beamlet 118 may determine how itself would have to steer the galvo mirror(s) 212 to direct the laser beam 200 to that point. This ensures that if called upon to perform a lasing task 134, the beamlet 118 is able to accurately steer the laser beam to the locations on the build area 106.

Furthermore, during operation of the lasing tasks 134, the beamlets 118 that are passive and not being used to melt powdered metal may observe the laser beams 200 to determine any errors. For example, the beamlets 118 may determine whether the laser beams 200 are melting the powdered metal at the proper location, within certain tolerances, etc. For a lasing task 134, the beamlets 118 that are passive may provide the imaging beams 214 to the 3D printing system 100 that, in turn, may determine whether the laser beams 200 are at the proper location.

The use of multiple of the imaging sensors 126 disposed across the beamlets 118 may eliminate error in directing the laser beams 200 to locations on the build area 106. For example, as multiple of the imaging sensors 126 are used, redundant information may be computed and the redundant information may ensure that the beamlets 118 agree, or are looking at, the same points on the build area 106. As such, the greater number of the imaging sensors 126 that are used to observe the point of the master laser beam 404 may equate to a greater accuracy for steering the laser beams across the beamlets 118.

In some instances, the master laser is selected via a round robin scheme. In some instances, to ensure that the master laser itself is accurately aligned on the build area 106, or on the build module 104, a beamlet 118 of the master laser may be instructed to image fiducials 602. That is, the imaging sensor 126 may receive an imaging beam 214 of the fiducial 604 to determine whether it's aligned on the build area 106 or the build module 104. If the beamlet 118 is misaligned, the beamlet 118 may be realigned and that that change may be propagated throughout the other beamlets.

In some instances, the master laser may be selected via a voting scheme. For example, a predetermined amount (e.g., three, five, ten, etc.) of the beamlets 118 may image the fiducial 604. Each of the beamlets 118 may then determine a deviation of itself from the fiducial 604. If the beamlets 118 are off by a certain threshold, or more than an acceptable amount, that beamlet 118 may be misaligned and not selected as the master laser. However, the one that is closest to the fiducial 604, or most accurately determines the location of the fiducial 604 (e.g., is off by the least amount), may be selected as the master laser.

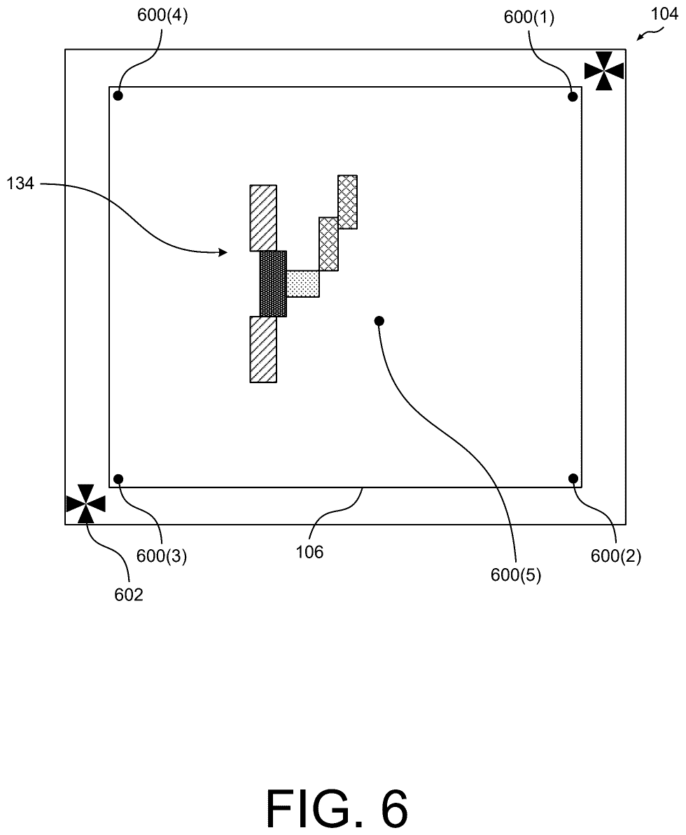

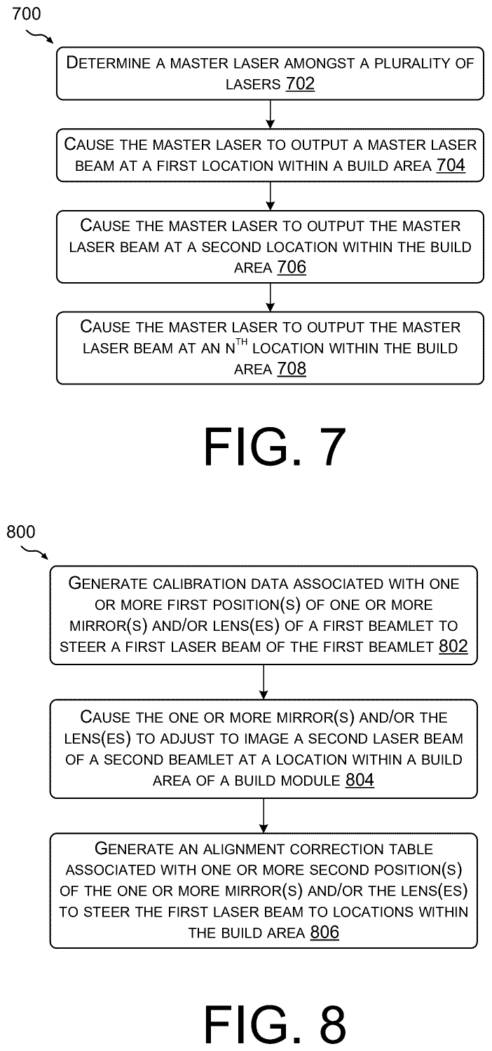

FIGS. 7-10 illustrate various processes related to aligning lasers, according to examples of the present disclosure. The processes described herein is illustrated as collections of blocks in logical flow diagrams, which represent a sequence of operations, some or all of which may be implemented in hardware, software, or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures, devices, and systems described in the examples herein, such as, for example those described with respect to FIGS. 1-6, although the processes may be implemented in a wide variety of other environments, architectures, devices, and systems.

FIG. 7 illustrates an example process 700 for aligning lasers, according to an example of the present disclosure. At 702, the process 700 may include selecting a master laser amongst a plurality of lasers. For example, a lasing module 102 may include a plurality of the optical assemblies 110 having beamlets 118 with lasers 124. One or more of the lasers 124 amongst the optical assemblies 110, or the beamlets 118, may be selected as the master laser. In some instances, a round-robin or voting scheme may be used to select the master laser. Selection of the master laser may be used to align other lasers 124 across the beamlets 118. In some instances, more than one of the lasers 124 may be selected as the master laser, and/or different master lasers may be selected at different instances in time.

At 704, the process 700 may include causing the master laser to output a laser beam at a first location within a build area. For example, the master laser may output the laser beam at the first location in the build area 106. In some instances, the master laser may output the laser beam 200 before, during, or after a layer of a part (e.g., lasing tasks 134) are being manufactured within the build area 106. The first location on the build area 106 may be based at least in part on the location of the part being manufactured, for example, to ensure that the first location does not interfere with the part being manufactured. While the master laser outputs the laser beam at the first location, the beamlets 118 may adjust their galvo mirror(s) 212 and/or lens(es) to align with the first location (e.g., via the imaging beams 214). In some instances, prior to instructing the master laser to output the master laser beam, the beamlets 118 may be aligned with the build module 104 (e.g., based on identifying a height of the build module 104 or position of the build module 104 relative to the beamlet). A grid-based alignment, fiducials, etc., may be used to align the beamlets 118 with the build module 104.

At 706, the process 700 may include causing the master laser to output the laser beam at a second location within a build area. For example, the master laser may output the laser beam at the second location in the build area 106. The second location may be different than the first location. In some instances, the master laser may output the laser beam 200 before, during, or after a layer of a part (e.g., lasing tasks 134) are being manufactured within the build area 106. The second location on the build area 106 may be based at least in part on the location of the part being manufactured, for example, to ensure that the second location does not interfere with the part being manufactured. At the second location, the beamlets 118 may adjust their galvo mirror(s) 212 and lens(es) to align with the second location (e.g., via the imaging beams 214).

At 708, the process 700 may include causing the master laser to output the laser beam at an nth location within the build area. For example, the master laser may output the master laser beam at the nth location in the build area 106. At the nth location, the beamlets 118 may adjust their galvo mirror(s) 212 and lens(es) to align with the nth location (e.g., via the imaging beams 214).

In some instances, the master laser that outputs the master laser beam to the first location, second location, and/or the nth location may be the same. Alternatively, more than one master laser across the beamlets 118 may be used to output the master laser beams at the first location, the second location, and/or the nth location. In some instances, the process 700 may be repeated for a given run time of the lasers 124 (e.g., every hour), a certain number of layers of the part being manufactured (e.g., every 100 layers), a certain number of the lasing tasks 134, and so forth.

FIG. 8 illustrates an example process 800 for generating the calibration data 136 and the alignment correction tables 138. At 802, the process 800 may include generating the calibration data 136 associated with one or more first positions of one or more galvo mirror(s) and/or lens(es) of a first beamlet to steer a first laser beam of the first beamlet. For example, to generate the calibration data 136, the galvo mirror(s) 212 and/or lens(es) of the beamlet 118 may be adjusted to steer the laser beam 200 to different locations on the calibration map 300. The imaging beams 214 may be received by the imaging sensor 126 of the beamlet 118 in order to align with the points on the calibration map 300. When aligned with the points 600, the position of the galvo mirror(s) 212 and/or lens(es) may be recorded. In some instances, prior to generating the calibration data 136, the imaging sensor 126 and the laser 124 may be aligned within the beamlet 118.

In some instance, generating the calibration data 136 may occur without with laser 124 outputting the laser beam 200. For example, given that the laser 124 and the imaging sensor 126 may be aligned, the imaging sensor 126 may receive the imaging beams 214 to generate the calibration data 136.

At 804, the process 800 may include causing the one or more galvo mirror(s) and/or the lens(es) to adjust to image a second laser beam of a second beamlet at a location within a build area of a build module. For example, to align the lasers 124, a master laser may output the laser beam 200 on the build area 106. The other beamlets may then image the master laser, via the imaging beams 214, to align with the master laser. This may include imaging the master laser beam and/or the melt pool created by the master laser. The galvo mirror(s) 212 and/or lens(es) may be adjusted, steered, focused, etc., in order to align the imaging beams 214 with the laser beam 200.

At 806, the process 800 may include generating an alignment correction table associated with one or more second position(s) of the one or more galvo mirror(s) and/or the lens(es) to steer the first laser beam to the locations within the build area. For example, after, or as part of adjusting the galvo mirror(s) 212 and/or the lens(es) to align with the laser beam 200, the beamlet 118 or the optical assemblies 110 may generate the alignment correction table 138. As discussed herein, the alignment correction table 138 may be associated with a correction to the calibration data 136 such that the beamlets 118 are all referenced to the same locations within the build area 106.

Although the process 800 is described as generating the alignment correction table 138 based on one location of the master laser beam, the process 800 may be repeated to generate the alignment correction table 138 across a range of locations on the build area 106. Moreover, each of the beamlets 118 may include an alignment correction table 138. The process 800 is therefore associated with aligning the beamlets 118 such that, during performance of the lasing tasks 134, the beamlets 118 may be instructed to perform the lasing tasks 134 and the beamlets 118 agree with where the points are on the build area 106.

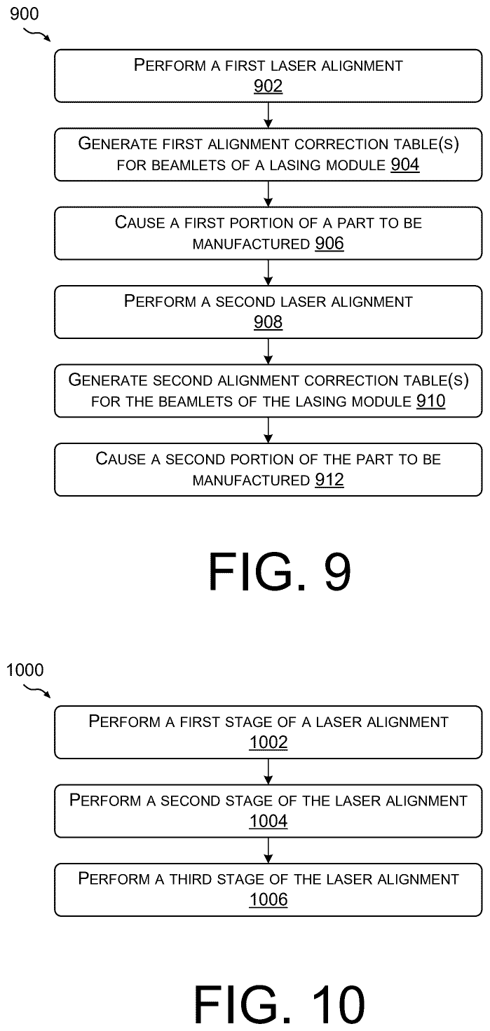

FIG. 9 illustrates an example process 900 associated with performing laser alignment, according to an example of the present disclosure. At 902, the process 900 may include performing a first laser alignment. For example, a master laser may be instructed to output a laser beam within a build area 106, and other beamlets 118 may be instructed to align with the laser beam 200 within the build area 106. The imaging beams 214 may be used to align the beamlets 118 and the laser beams 200, for example, via adjusting the galvo mirror(s) 212 and/or the lens(es).

At 904, the process 900 may include generating first alignment correction table(s) for beamlets of a lasing module. For example, as the beamlets 118 are adjusted to align with the laser beam 200, a position of the galvo mirror(s) 212 and/or lens(es) may be adjusted. These positions may be recorded and used to generate the alignment correction table 138 for the individual beamlets 118. In some instances, the galvo mirror(s) 212 and/or lens(es) may be adjusted such that the beamlets 118 are aligned to within a certain threshold distance (e.g., 10 microns) of the master laser beam.

At 906, the process 900 may include causing a first portion of a part to be manufactured. For example, once the beamlets 118 are aligned, portions of the part may be manufactured via the laser beams 200 generated across the beamlets 118.

At 908, the process 900 may include performing a second laser alignment. For example, a master laser (whether the same or different master laser than at 904) may be instructed to output a laser beam within the build area 106, and other beamlets 118 may be instructed to align with the laser beam 200 within the build area 106. The imaging beams 214 may be used to align the beamlets 118 and the laser beams 200, for example, via adjusting the galvo mirror(s) 212 and/or the lens(es). In some instances, the second laser alignment may be performed after a certain number of layers are formed, after a certain number of the lasing tasks, after a certain period of time since performing the first laser alignment, etc.

At 910, the process 900 may include generating second alignment correction table(s) for beamlets of the lasing module. For example, as the beamlets 118 are adjusted to align with the laser beam 200, a position of the galvo mirror(s) 212 and/or the lens(es) may be adjusted. These positions may be recorded and used to generated the alignment correction table 138 for the individual beamlets 118.

At 912, the process 900 may include causing a second portion of the part to be manufactured. For example, once the beamlets 118 are aligned, portions of the part may be manufactured via the laser beams 200 generated across the beamlets 118.

FIG. 10 illustrates an example process 1000 associated with aligning lasers. In some instances, the process 1000 may include different stages. At 1002, the process 1000 may include performing a first stage of a laser alignment. In some instances, at the first stage, components of the individual beamlets 118 may be aligned. The first stage may involve testing, validating, and qualifying that the lens(es) are able to focus the laser beam to different spot sizes. The imaging sensor 126 may be tuned to image the laser beams 200. The alignment at the first stage permits the imaging sensor 126 to locate the laser beam 200 Lens(es), mirror(s), etc., may be controlled to align the imaging beams 214 and the laser beam 200.

At 1004, the process 1000 may include performing a second stage of the laser alignment. In some instances, at the second stage the beamlets 118 may be calibrated using the galvo mirror(s) 212. The galvo mirror(s) 212 may be moveable over a range of distances, and different combinations of steering the galvo mirror(s) 212 may be achieved to direct the laser beam 200 to locations within the build area 106. A grid, coordinate system, or other set of fiducials on a calibration map may be used to calibrate the galvo mirror(s) 212. The galvo mirror(s) 212 may be actuated over a range of positions to understand the position of each of the galvo mirror(s) 212 to steer the laser beams 200 and/or imaging beams 214 to the locations on the calibration map. As the galvo mirror(s) are moved, the imaging sensor 126 may image the points on the calibration map to understand how the galvo mirror(s) 212 are actuated to image a particular locations on the calibration map. Being that the imaging sensor 126 has been previously aligned with the laser 124, at 1002, the laser 124 may not need to be actuated to understand where the laser beam 200 will be directed at particular positions of the galvo mirror(s) 212. The second stage may involve generating the calibration data 136.

At 1006, the process 1000 may include performing a third stage of the laser alignment. The third stage may include aligning the individual beamlets 118 with one another, such as aligning the beamlets 118 across the optical assemblies 110. Aligning the individual beamlets 118 ensures that the beamlets 118 are each oriented within the same coordinate space on the build area 106 and that the beamlets 118 are in agreement as to the points on the build area 106.

In some instances, the first stage and/or the second stage may be performed offline, that is, prior to installation or commissioning of the optical assemblies 110 on the lasing module 102. Performing the first stage and/or the second stage offline may reduce an amount of time to align the optical assemblies 110 when installed (or commissioned) on the lasing module 102. In some instances, the third stage may occur when the optical assemblies 110 are installed on the lasing module 102 or otherwise commissioned. In some instances, after installing the optical assemblies, but prior to manufacturing of a part, the beamlets 118 may image a grid, coordinate system, or other set of fiducials on the lasing module 102, the build module 104, etc., or other structure. The third stage may also be performed during performance of the lasing tasks 134.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
generating, for a first beamlet of a lasing module of a 3D printing system, calibration data that represents a position of a mirror for directing a first laser beam of the first beamlet to a first location within a build area;
causing a second beamlet of the lasing module to output a second laser beam at a second location;
receiving, via an imaging sensor of the first beamlet, image data representing the second laser beam at the second location; and
generating, based at least in part on the calibration data and the image data, an alignment correction table for directing the first laser beam to the second location.

2. The method of claim 1, wherein the calibration data further represents a second position of the mirror for directing the first laser beam to a third location within the build area.

3. The method of claim 2, further comprising:
causing the second beamlet to output the second laser beam at the third location;
receiving, via the imaging sensor, second image data representing the second laser beam at the third location; and
generating, based at least in part on the calibration data and the second image data, a second alignment correction table for directing the first laser beam to the third location.

4. The method of claim 1, wherein:
the first beamlet includes a lens; and
the calibration data represents a second position of the lens for directing the first laser beam to the second location.

5. The method of claim 1, further comprising:
generating, for a third beamlet of the lasing module, second calibration data that represents a second position of a second mirror for directing a third laser beam of the third beamlet to the second location within the build area;
receiving, via a second imaging sensor of the third beamlet, second image data representing the second laser beam at the second location; and
generating, based at least in part on the second calibration data and the second image data, a second alignment correction table for directing the third laser beam to the second location.

6. The method of claim 1, wherein the first location and the second location are a same.

7. The method of claim 1, further comprising:
determining a difference between the first location and the second location; and
determining, based at least in part on the difference, a second position of the mirror for directing the first laser beam to the second location, the second position being indicated within the alignment correction table.

8. A method comprising:
determining, amongst a plurality of beamlets of a lasing module, a first beamlet for outputting a first laser beam within a build area of a build module;
causing a second beamlet of the plurality of beamlets to image the first laser beam; and
generating, for the second beamlet, data associated with a position of a mirror and a position of lens of the second beamlet, the data being used to direct a second laser beam of the second beamlet to locations within the build area.

9. The method of claim 8, further comprising generating second data associated with the second beamlet, the second data indicating positions of the mirror and positions of the lens for directing the second laser beam to the locations.

10. The method of claim 9, wherein the data is based at least in part on the second data.

11. The method of claim 8, further comprising causing, based at least in part on the data, the second laser beam to manufacture a portion of a part on the build area.

12. The method of claim 11, further comprising:
causing, subsequent to the portion of the part being manufactured by the second laser beam, the first beamlet to output the first laser beam within the build area;
causing the second beamlet to image the first laser beam; and
generating, for the second beamlet, a second data associated with a second position of the mirror and a second position of the lens, the second data being used to direct the second laser beam to the locations within the build area.

13. The method of any of claim 8, further comprising:
causing a third beamlet of the plurality of beamlets to image the first laser beam; and
generating, for the third beamlet, second data associated with a second position of a second mirror and a second position of a second lens of the third beamlet, the second data being used to direct a third laser beam of the third beamlet to the locations within the build area.

14. The method of claim 8, wherein causing the second beamlet to image the first laser beam includes positioning the mirror at a second position and the lens at a second position, further comprising;
causing the first beamlet to output the first laser beam at a location within the build area; and
determining at least one of:
a first difference between the second position of the mirror and the position of the mirror to direct the second laser beam to the location, or
a second difference between the second position of the lens and the position of the lens to direct the second laser beam to the location.

15. The method of claim 14, wherein generating the data is based at least in part on the at least one of the first difference or the second difference.

16. A 3D printing system comprising:
a build module having a build area on which a part is manufactured;
a lasing module including:
a first optical assembly having:
a first beamlet, wherein the first beamlet is associated with first calibration data that indicates first positions of one or more first mirrors or one or more first lenses for directing a first laser beam of the first beamlet to locations on the build area, and
a second beamlet, wherein the second beamlet is associated with second calibration data that indicates second positions of one or more second mirrors or one or more second lenses for directing a second laser beam of the second beamlet to the locations on the build area; and
a second optical assembly having:
a third beamlet, wherein the third beamlet is associated with third calibration data that indicates third positions of one or more third mirrors or one or more third lenses for directing a third laser beam of the third beamlet to the locations on the build area, and
a fourth beamlet, wherein the fourth beamlet is associated with fourth calibration data that indicates fourth positions of one or more fourth mirrors or one or more fourth lenses for directing a fourth laser beam of the fourth beamlet to the locations on the build area;
one or more processors; and
one or more non-transitory computer-readable media storing instructions that, when executed, cause the one or more processors to perform acts comprising:
causing the first beamlet to output the first laser beam at a first location on the build area,
causing the second beamlet to image the first laser beam at the first location,
causing the third beamlet to image the first laser beam at the first location,
causing the fourth beamlet to image the second laser beam at the first location,
generating a first alignment correction table for the second beamlet, the first alignment correction table indicating fifth positions of the one or more second mirrors and the one or more second lenses for directing the second laser beam to the first location,
generating a second alignment correction table for the third beamlet, the second alignment correction table indicating sixth positions of the one or more third mirrors and the one or more third lenses for directing the third laser beam to the first location, and
generating a third alignment correction table for the fourth beamlet, the third alignment correction table indicating seventh positions of the one or more fourth mirrors and the one or more fourth lenses for directing the fourth laser beam to the first location.

17. The 3D printing system of claim 16, wherein:
the first alignment correction table is used by the second beamlet to manufacture a first portion of the part;
the second alignment correction table is used by the third beamlet to manufacture a second portion of the part; and
the third alignment correction table is used by the fourth beamlet to manufacture a third portion of the part.

18. The 3D printing system of claim 16, wherein the second beamlet, the third beamlet, and the fourth beamlet simultaneously image the first laser beam at the first location.

19. The 3D printing system of claim 16, wherein at least one of:
generating the first alignment correction table is based at least in part on the first calibration data;
generating the second alignment correction table is based at least in part on the second calibration data; or
generating the third alignment correction table is based at least in part on the third calibration data.

20. The 3D printing system of claim 16, wherein:
the second calibration data indicates eighth positions of the one or more second mirrors or the one or more second lenses for directing the second laser beam to the first location; and
the eighth positions are different than the fifth positions.
